(19) United States
(12) Patent Application Publication
(10) Pub. No.: US 2008/0191999 A1
(43) Pub. Date: Aug. 14, 2008

(54) METHOD FOR DISPLAYING A MOVING IMAGE ON A DISPLAY

(75) Inventor: Wolfgang ECKHARDT, Weingarten (DE)

Correspondence Address: SUGHRUE MION, PLLC, 2100 PENNSYLVANIA AVENUE, N.W., SUITE 800, WASHINGTON, DC, 20037, US

(73) Assignee: EIZO GmbH, Karlsruhe (DE)

(21) Appl. No.: 12/028,693

(22) Filed: Feb. 8, 2008

(30) Foreign Application Priority Data
Feb. 9, 2007 (DE) 102007007201.7
Feb. 23, 2007 (DE) 102007009014.7

(51) Int. Cl. G09G 3/36

(52) U.S. Cl. 345/102

(57) ABSTRACT

Disclosed is a method for displaying a moving image on a display, such that all the pixel rows of the display are addressed during each image formation, and a backlight for displaying the image information backlights the pixel rows. The display of moving images is improved by delaying the backlighting during each image formation.

This application claims priority under 35 U.S.C. 119(a) to German Patent Application No. 10 2007 007 201.7 filed on Feb. 9, 2007, the entire contents of which are hereby incorporated by reference. This application also claims priority under 35 U.S.C. 119(a) to German Patent Application No. 10 2007 009 014.7, filed on Feb. 23, 2007, the entire contents of which are hereby incorporated by reference.

### BACKGROUND OF THE INVENTION

1. Field of Invention

The present invention relates to a method for displaying a moving image on a display screen, such that all the pixel rows of the display are addressed during each image formation, and a backlight provides backlighting for display of image information.

2. Description of the Related Art

In the state of the art, a cold cathode fluorescent lamp (CCFL) is arranged row-by-row is used to backlight an LCD screen. Light is emitted in all directions in the display and a reflector is provided to reflect the light emitted toward the rear in the direction of the LCD screen. Such a display can be used in the medical field in particular, where a high contrast in graphic displays is desired in the context of diagnostics. In addition, very little blurring of movement of a moving object displayed on an LCD screen is desired.

LCD screens are among the so-called hold-type displays, in which the contents of the display are preserved during the duration of a frame, i.e., during a frame period. The liquid crystals of the LCD screen, for example, have a response time of approximately 8 ms, which represents the time for a change in the brightness of one pixel from 10% to 90%. Because of this response time, an addressed scan line does not light up immediately with the “correct” brightness. Therefore, the edges of the displayed moving object appear blurred, i.e., without definition, for the observer due to integration of brightness over the duration of the display. This interfering blurring of movement is also increased by the fact that the actual movement of an object displayable on the display is greater than the limit of resolution of the human eye. The human eye normally perceives an interval of approximately 0.15 mm, but an addressed scan line at an image refresh rate of 60 Hz is visible to the human eye for a duration of approximately 17 ms, during which the object moving at a speed of 0.1 mm/s travels a distance of 1.7 mm.

A blinking backlight is described in a publication “Rasante Zeiten, Techniken zur besseren Bewegtbilddarsellung auf Flachbildschirmen” [Fast Times, Techniques for Better Display of Moving Images on Flat Display Screens] c't 2005, no. 9. The background lighting switches off briefly before the end of a frame and thereby reduces the light intensity to zero after the illumination of the image, so the brightness integral and therefore also the slope overload are reduced. However, it is a disadvantage that so-called leading and trailing ghost images of the moving object can be seen if the liquid crystals (pixels) are not yet oriented and still contain information from a preceding image and/or if the liquid crystals become reoriented again and therefore already contain information from the next image. A moving graphic display can be improved with a scanning backlight. During a frame period, lamps arranged in rows are switched on and off in synchronization with the image formation. However, it is a disadvantage that the scanning backlight requires a plurality of lamps arranged in rows.

### SUMMARY OF THE INVENTION

An object of the present invention is to provide a method of the type defined in the introduction with which the display of a moving image is improved. According to one formulation, this object is achieved by addressing all pixel rows of the display during each image formation, backlighting the pixel rows by a backlight to display the image information; and delaying the backlighting after each image formation during a delay time.

The invention is directed to the idea of not backlighting a pixel that has been addressed during the change in state, i.e., during its change in brightness. With regard to an LCD screen, this means that the liquid crystals are not backlit during the orientation of the liquid crystals of the display. The backlighting is turned on only after all the pixel rows, e.g., 1024 pixel rows with 1280 pixels each, have been addressed during one frame period and after all the liquid crystals are oriented after being addressed. This ensures that blurring of movement during the display of a moving object is prevented.

It is an advantage that a complex LED backlight, that has a plurality of light emitting diodes arranged in rows and that has a complex electronic control system, is not necessary for backlighting. A single light emitting diode, e.g., in the form of one lamp, is sufficient for backlighting the pixel rows.

In one embodiment of the invention, it is provided that the delay time corresponds essentially to the sum of the time for the change of state of a pixel after being addressed and a flash time for backlighting the pixel rows. This ensures that in any case the backlight remains turned off during the “movement” of the pixels and/or during the orientation of the liquid crystals, which results in a change in brightness.

In another embodiment of the present invention, the flash time corresponds essentially to the perception time of the human eye. This means that the delay between two successive image formations, which is obtained from the sum of the response time of a liquid crystal and the flash time, can be selected to be short, so that the delay does not have an interfering effect with regard to a flicker-free graphic display.

### BRIEF DESCRIPTION OF THE DRAWINGS

The invention and an exemplary embodiment of the present invention are now described with reference to the drawings:

FIGS. 1 and 2 show image formation time diagrams and

FIG. 3 shows an LCD screen image formation.

### DETAILED DESCRIPTION OF EXEMPLARY EMBODIMENTS OF THE INVENTION

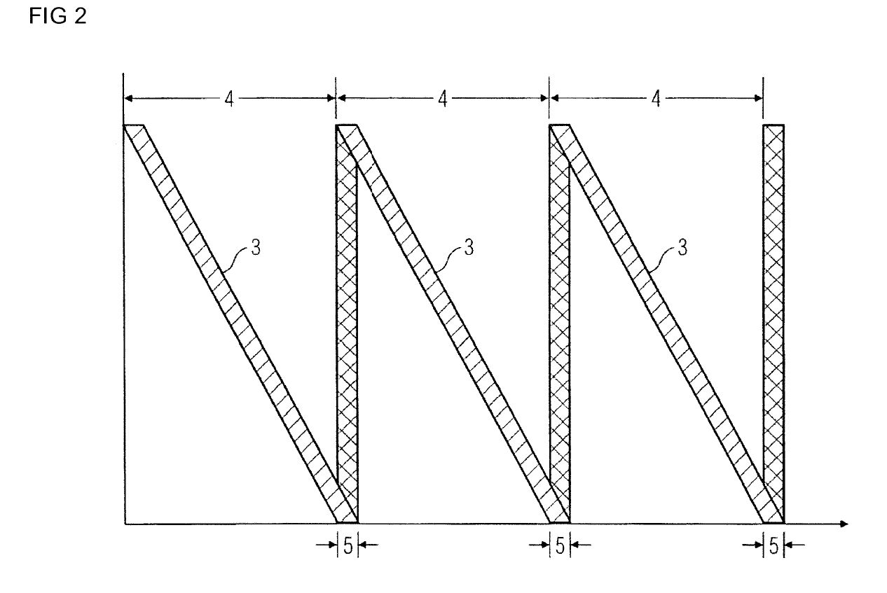

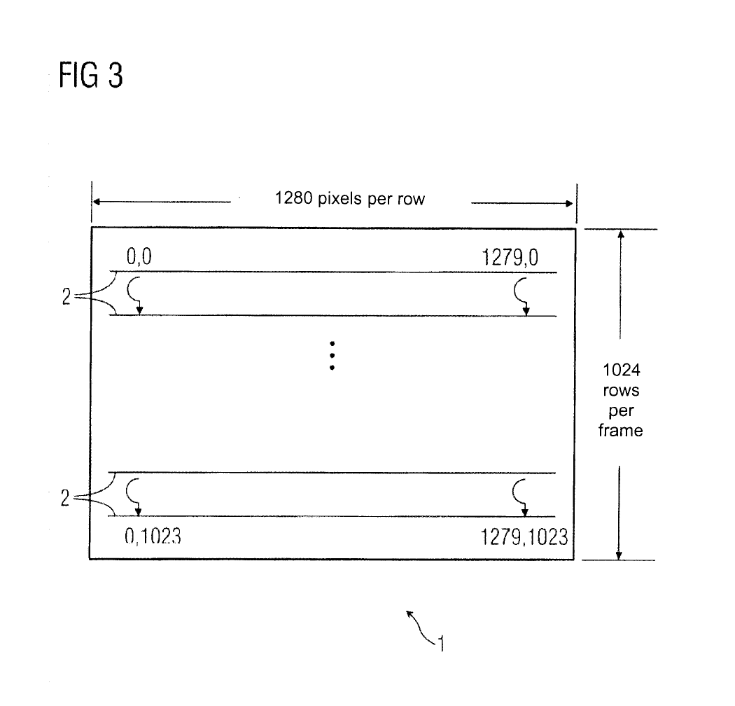

Reference is first made to FIG. 3, which shows an image formation on a display 1 of an LCD screen during a frame period with a frequency of 120 Hz. It is assumed that all 1024 rows 2, each with 1280 pixels (liquid crystal cells) are addressed during the frame period, such that corresponding voltages are applied row by row to the liquid crystal cells. The cells become oriented in accordance with their response time, such that the image information on a display of the LCD screen is visible for an observer due to backlighting of the liquid crystal cells by a backlight. The response time of the liquid crystals during which the liquid crystals become oriented and which represents the time until a pixel undergoes a change in brightness from approximately 10% to approximately 90% amounts to 4 ms, for example. After this frame period, another image is created during a subsequent additional frame period, which is represented in FIG. 2 in the form of a scrolling bar 3 within the respective frame period 4 of 8.3 ms (corresponding to 120 Hz). The period of time for orienting the liquid crystals after they have been addressed and controlled is indicated by the width of the respective scrolling bar 3. Due to the fact that liquid crystals are not yet completely oriented during the flash, i.e., during the backlighting of the pixel rows by the backlight in time intervals 5 and liquid crystals are already reoriented due to new image information from the following frame period, the result is a blurring of the movement in the form of “leading and trailing ghost images” which have an interfering effect on the observer of the display 1.

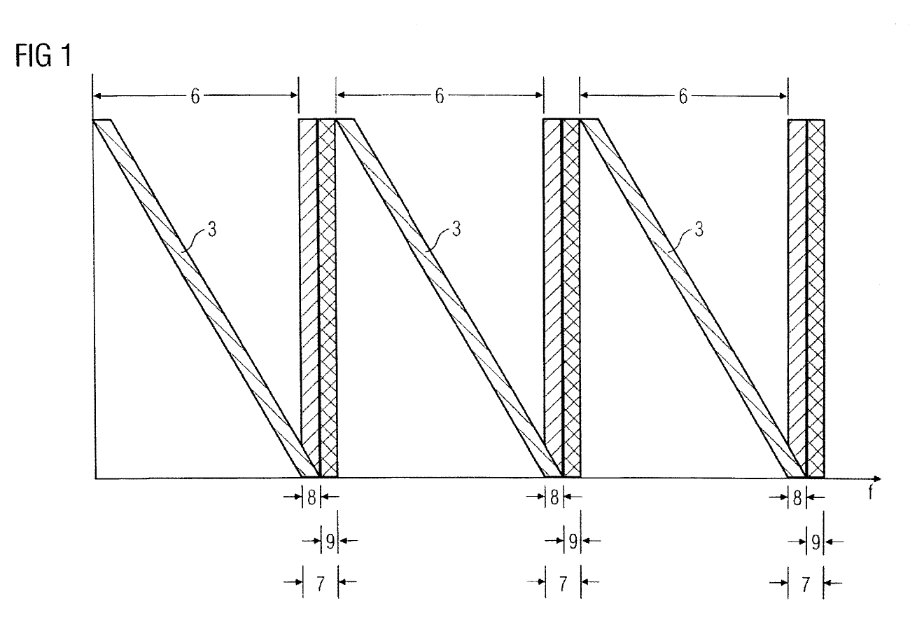

To avoid backlighting during the orientation of the liquid crystals, after each image formation the pixel rows are to be backlit only after a delay. In this context reference is made to FIG. 1, which shows an image formation time diagram.

Image formation, takes place during an interval 6 (duration 8.3 ms) which corresponds to the frame period 4 according to FIG. 2. However, another image is formed in a following interval 6 only after a delay period 7. The delay time 7 is essentially equal to the sum of a response time 8, which represents the time until the change in brightness of a pixel from approx. 10% to approx. 90%, and a flash time 9, which corresponds to the time for backlighting the pixel rows during which the backlight is turned on and the image is therefore visible for an observer of the display. This ensures that all liquid crystals are fully oriented while they are backlit. The flash time is selected so that it corresponds essentially to the perception time of the human eye. In an exemplary embodiment of the present invention, 4 ms is selected as the delay time, such that liquid crystals having a response time of 2 ms are used and the flash time is 2 ms. Although the period duration is thereby increased to 12.3 ms (image formation interval of 8.3 ms plus a delay time of 4 ms), the image that is visible to the user and is displayed on the display screen appears without flicker because of the selected image formation interval 6 of 8.3 ms (120 Hz).

What is claimed is:

1. A method for displaying a moving image on a display, comprising:
addressing all pixel rows of the display during each image formation; and
backlighting the pixel rows by a backlight to display image information for the image only after delaying the backlighting after each image formation for a given delay time.

2. The method as claimed in claim 1, wherein the delay time corresponds to a sum of a time for a change in state of a pixel after being addressed and a flash time for backlighting the pixel rows.

3. The method as claimed in claim 2, wherein the flash time corresponds to a perception time of a human eye.
